(19) United States
(12) Patent Application Publication
(10) Pub. No.: US 2005/0098714 A1
(43) Pub. Date: May 12, 2005

(54) Measuring arrangements for testing workpieces, and a method for metrological instrumentation of workpieces

(76) Inventors: Alfred Ecker, Munchen (DE); Ernst Feitzelmayer, Munchen (DE); Gerhard Heider, (US); Josef Wenzl, (US)

Correspondence Address: CROWELL & MORING LLP;INTELLECTUAL PROPERTY GROUP, P.O. BOX 14300, WASHINGTON, DC, 20044-4300, US

(21) Appl. No.: 10/646,708

(22) Filed: Aug. 25, 2003

(30) Foreign Application Priority Data
Aug. 24, 2002 (DE) 102 38 862.8

(51) Int. Cl. G01J 1/04; G01J 5/08

(52) U.S. Cl. 250/227.14; 250/227.15

(57) ABSTRACT

The invention relates to a measuring arrangement for testing workpieces, having at least one optical fibre (11, 12, 13, 14, 15, 16, 17, 18) assigned to a workpiece (10), in which or each the optical fibre (11, 12, 13, 14, 15, 16, 17, 18) is designed as a Bragg grating sensor, and in which the or each optical fibre (11, 12, 13, 14, 15, 16, 17, 18) is arranged in the region of a surface of the workpiece.

The invention relates to a measuring arrangement for testing workpieces and to a method for metrological instrumentation of workpieces.

Fibre-optic Bragg grating sensors are known from metrology. A permanent increase in refractive index along the axis of an optical fibre is produced at freely selectable points in a core thereof by means of a structured exposure of an optical fibre—also termed optical conductor—with the aid of UV light. The modulation in the refractive index of the optical fibre thereby yielded is variable in respect of its length of period, amplitude and overall length. This structure is denoted as a Bragg grating and is metrologically useful. Such Bragg grating sensors known from the prior art can be used as strain sensors and/or temperature sensors.

Starting herefrom, the present invention is based on the problem of providing a measuring arrangement for testing workpieces, and a method for metrological instrumentation of workpieces.

This problem is solved by means of a measuring arrangement for testing workpieces in accordance with claim 1. The method according to the invention for metrological instrumentation of workpieces is characterized by the features of independent claim 12.

The outlay on instrumentation for the component can be reduced substantially by the inventive use of the optical fibres designed as a Bragg grating sensor. There is likewise a reduction in the effects of instrumentation which can impair the behaviour of the component during the test or when being trialed. Again, when use is made of the optical fibres designed as a Bragg grating sensor, it is possible to increase the number of measuring points, as a result of which test results are rendered yet more informative.

The or each optical fibre designed as a Bragg grating sensor is preferably mounted, in particular bonded, directly on the surface of the workpiece. This permits a metrological instrumentation of the component in a particularly simple way.

According to an alternative advantageous development of the invention, the or each optical fibre designed as a Bragg grating sensor is integrated in the surface of the workpiece, there being introduced into the surface of the workpiece recesses whose width and depth are matched to the diameter of the optical fibres designed as Bragg grating sensors, and an optical fibre being arranged in the recesses. This minimizes the effects of instrumentation on the component to be trialed.

According to a preferred development of the invention, a plurality of optical fibres designed as Bragg grating sensors are arranged in a different geometrical configuration on a surface of the workpiece, specifically with different curvatures. It is possible thereby to accomplish optimized placing of the measuring points with particularly simple means.

Preferred developments of the invention emerge from the dependent subclaims and the following description. Exemplary embodiments of the invention are explained in more detail with the aid of the drawing, in which:

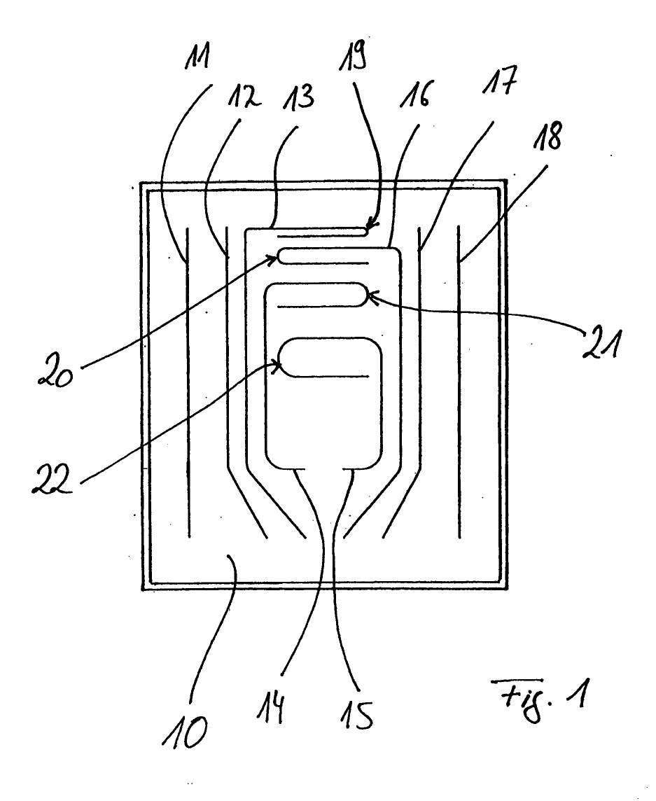

FIGURE 1 shows a diagrammatic illustration of the inventive measuring arrangement for testing workpieces.

A workpiece 10 with metrological instrumentation is illustrated very diagrammatically in FIGURE 1, the workpiece 10 being a blade of a turbine. However, the workpiece 10 can also be other dynamically loaded components of a turbine, for example a housing part or the like.

In accordance with FIGURE 1, a plurality of optical fibres 11, 12, 13, 14, 15, 16, 17 and 18 designed as Bragg grating sensors are arranged in the region of a surface of the workpiece 10.

Two first optical fibres 1, 18, which are both designed as Bragg grating sensors, are positioned without curvature in the form of a straight line on the surface of the workpiece 10. In accordance with FIGURE 1, these optical fibres 11, 18 are assigned to an outer edge region of the workpiece 10, specifically the turbine blade. A second optical fibre 12, 17 is positioned in each case next to these two first optical fibres 11, 18. The two second optical fibres 12, 17 are arranged in accordance with FIGURE 1 on the surface of the workpiece 10 in such a way that the same have an angular course, a first section of these fibres 12, 17 running approximately parallel to the first optical fibres 11, 18 and a second section of the same being designed angled off from this first section. A total of four third optical fibres 13, 14, 15 and 16, which are designed as Bragg grating sensors, are positioned on the surface of the workpiece 10 between the two second optical fibres 12, 17. The third optical fibres 13, 14, 15 and 16 have in common that the same in each case have a curved section in which the optical fibre 13, 14, 15 and 16 is angled off at approximately 180°. Consequently, neighbouring sections of an optical fibre 13, 14, 15 and 16 run approximately parallel to one another in the region of the curved section. As may be gathered from FIGURE 1, the curved sections of the third optical fibres 13, 14, 15 and 16 differ with respect to their radii of curvature. The optical fibre 13 has a curved section 19, the radius of curvature of the curved section 19 corresponding to a unit of measurement. A radius of curvature of the curved section 20 of the optical fibre 16 corresponds to two units of measurement. Consequently, a curved section 21 of the optical fibre 14 has a radius of curvature of three units of measurement, and a curved section 22 of the optical fibre has a radius of curvature of five units of measurement. The larger the radius of curvature of the curved sections, the further spaced apart from one another are the sections of the optical fibres 13, 14, 15 and 16 which run approximately parallel to one another in the region of the curved sections. As may also be gathered from FIGURE 1, two of the third optical fibres 21, 22 have an additional curved section of approximately 90° in addition to the curved section of approximately 180°.

Consequently, a plurality of optical fibres 11, 12, 13, 14, 15, 16, 17 and 18, designed as Bragg grating sensors, are arranged on the surface of the workpiece 10 in a different geometrical configuration and with different curvatures. The optical fibres 11, 12, 13, 14, 15, 16, 17 and 18, designed as Bragg grating sensors, can in this way be arranged on the workpiece 10 such that a multiplicity of different measuring points can be realized with particularly simple structural means.

According to a first advantageous alternative for developing the invention, the optical fibres 11, 12, 13, 14, 15, 16, 17 and 18 are bonded directly on the surface of the workpiece. For this purpose, the optical fibres can be mounted on the workpiece with the aid of an adhesive, for example, which is normally used for mounting strain gauges. Again, the optical fibres can be bonded on the surface of the workpiece 10 with the aid of known lamination methods.

It is also possible as an alternative to this for the optical fibres 11, 12, 13, 14, 15, 16, 17 and 18 to be integrated into the surface of the workpiece 10. In this case, recesses which preferably have a width of 0.2 to 0.25 mm and a depth of 0.3 mm are introduced into the surface of the workpiece 10. The recesses are consequently matched with regard to their width and depth to the diameter of the optical fibres 11, 12, 13, 14, 15, 16, 17 and 18 designed as Bragg grating sensors. Moreover, the course of the recesses corresponds to the geometrical configuration with which the corresponding optical fibre is to be attached to the surface of the workpiece 10. The recesses therefore run either rectilinearly or in a curved shape or the shape of a circular arc.

Instrumentational influences on the workpiece can be minimized by the integration of the optical fibres designed as Bragg grating sensors into the surface of the workpiece 10.

It is particularly advantageous to use the measuring arrangement according to the invention on dynamically loaded components such as on turbine blades, for example. Vibrations and temperatures can be measured with the aid of the optical fibres designed as Bragg grating sensors. The influence exerted on the component as a consequence of the instrumentation or the arrangement of the optical fibres designed as Bragg grating sensors is minimal. A novel measurement technique is introduced into the development and trialing of turbines within the scope of the invention. Such a metrological design is particularly robust and has a long service life.

In the case of the inventive method for metrological instrumentation of workpieces, at least one optical fibre, which is designed as a Bragg grating sensor, is arranged in the region of a surface of the workpiece. It is possible again in this case for the optical fibres either to be bonded directly on the surface of the workpiece with the aid of a bonding technique or via a lamination method, or else for them to be integrated into the surface of the workpiece using encapsulation technology.

It is likewise possible to use optical fibres in order to pick off the measured values from the optical fibres designed as Bragg grating sensors, and to pass on the measured values to an electronic evaluation system. In the case where the workpiece 10 to be trialed is a turbine blade, these optical fibres can be guided through a blade root to pass on the measured values. The effect of this is to relieve the stress on the optical fibres.

Further geometrical configurations of the optical fibres are conceivable beyond the geometrical configuration, shown in FIGURE 1, of the optical fibres 11, 12, 13, 14, 15, 16, 17 and 18. Thus, the optical fibres can also be guided diagonally over a workpiece to be trialed.

High-temperature stable or polyimide-coated glass fibres which are designed as Bragg grating sensors are preferably used as optical fibres.

### List of Reference Numerals

Workpiece 10
Optical fibre 11
Optical fibre 12
optical fibre 13
Optical fibre 14
Optical fibre 15
Optical fibre 16
Optical fibre 17
Optical fibre 18
Curved section 19
Curved section 20
Curved section 21
Curved section 22

1. Measuring arrangement for testing workpieces, having at least one optical fiber assigned to a workpiece, wherein each optical fiber is designed as a Bragg grating sensor, and wherein each optical fiber is arranged in a region of a surface of the workpiece.

2. The measuring arrangement according to claim 1, wherein each optical fiber designed as a Bragg grating sensor is mounted directly on the surface of the workpiece.

3. The measuring arrangement according to claim 1, wherein each optical fiber designed as a Bragg grating sensor is integrated in the surface of the workpiece.

4. The measuring arrangement according to claim 3, wherein recesses are introduced into the surface of the workpiece said recesses each having a breadth and depth matched to a diameter of the optical fibers designed as Bragg grating sensors, and wherein said optical fibers are arranged in the recesses.

5. The measuring arrangement according to claim 1 wherein a plurality of said at least one optical fibers designed as Bragg grating sensors are arranged in a geometrical configuration different from other ones of said at least one optical fiber on a surface of the workpiece.

6. The measurement arrangement according to claim 5, wherein said plurality of optical fibers designed as Bragg grating sensors are arranged with curvatures which are different from said other ones of said at least one optical fiber on the surface of the workpiece.

7. The measuring arrangement according to claim 5 wherein at least one optical fiber designed as a Bragg grating sensor is arranged without curvature in the form of a straight line on the surface of the workpiece.

8. The measuring arrangement according to claim 5, wherein at least one optical fiber designed as a Bragg grating sensor is arranged in the form of an angular straight line on the surface of the workpiece in such a way that a first section of the fiber is angled off from a second section thereof.

9. The measuring arrangement according to claim 5, wherein at least one optical fiber designed as a Bragg grating sensor is arranged on the surface of the workpiece in such a way that the at least one fiber has at least one of a curved section of approximately 90° and a curved section of approximately 180° with neighbouring sections of the corresponding optical running approximately parallel to one another in the curved section of approximately 180°.

10. The measuring arrangement according to claim 1, wherein the workpiece is designed as a dynamically loaded component.

11. Use of a measuring arrangement according to claim 1 to determine the properties of a dynamically loaded component.

12. Method for metrological instrumentation of workpieces, at least one optical fiber designed as a Bragg grating sensor is arranged in the region of a surface of the workpiece.

13. The method according to claim 12, wherein each optical fiber designed as a Bragg grating sensor is mounted, directly on the surface of the workpiece.

14. The method according to claim 12, wherein each of said at least one optical fiber designed as a Bragg grating sensor is integrated in the surface of the workpiece with, recesses being introduced into the surface of the workpiece whose width and depth are matched to the diameter of the optical fibers designed as Bragg grating sensors, wherein an optical fiber is arranged in the recesses.

15. The method according to claim 12, wherein a plurality of said at least one optical fiber designed as Bragg grating sensors are arranged in a different geometrical configuration.

16. The measuring arrangement according to claim 2, wherein said each optical fiber is bonded directly on the surface of the workpiece.

17. The measuring arrangement according to claim 10, wherein the workpiece is designed as a blade of a turbine or housing of a turbine.

18. The method according to claim 13, wherein said each optical fiber is bonded directly on the surface of the workpiece.

19. The method according to claim 15, wherein said different geometrical configuration is a curvature.

20. Use of a measuring arrangement according to claim 11, wherein said dynamically loaded component is a blade of a turbine or a housing of a turbine.
